(19) United States
(12) Patent Application Publication
(10) Pub. No.: US 2016/0139867 A1
(43) Pub. Date: May 19, 2016

(54) APPARATUS FOR AND METHOD OF DETECTING LAYOUT OF MULTI DISPLAY APPARATUS

(71) Applicant: SAMSUNG ELECTRONICS CO., LTD., Suwon-si (JP)

(72) Inventors: Tae-hwan CHA, Yongin-si (KR); Dong-wook KIM, Suwon-si (KR); Min-jung KIM, Seoul (KR)

(21) Appl. No.: 14/859,398

(22) Filed: Sep. 21, 2015

(30) Foreign Application Priority Data
Nov. 17, 2014 (KR) 10-2014-0160057

(51) Int. Cl. G06F 3/14; H04N 5/232

(52) U.S. Cl. CPC G06F 3/1423; H04N 5/23229

(57) ABSTRACT

A detection apparatus for detecting a layout of a multi display apparatus is disclosed. The detection apparatus includes: a controller configured to control the multi display apparatus and to control an image capturing apparatus so that a plurality of display apparatuses included in the multi display apparatus display an image, and the image capturing apparatus captures an image of the multi display apparatus; and an image analyzer configured to detect a layout of the multi display apparatus based on the image captured by the image capturing apparatus.

### CROSS-REFERENCE TO RELATED APPLICATION

This application is based on and claims priority under 35 U.S.C. §119 to Korean Patent Application No. 10-2014-0160057, filed on Nov. 17, 2014, in the Korean Intellectual Property Office, the disclosure of which is incorporated by reference herein in its entirety.

### BACKGROUND

1. Field

The disclosure relates to an apparatus for and method of detecting a layout of a multi display apparatus.

2. Description of Related Art

A multi display apparatus displays an image via multiple display apparatuses. When the multi display apparatus is used, one large image may be displayed by displaying small images that together make up the large image. The multi display apparatus may be referred to as a large format display (LFD) or multi vision apparatus.

Layouts of display apparatuses forming the multi display apparatus need to be detected to use the multi display apparatus. Images to be respectively displayed by the display apparatuses are determined based on sizes, locations, etc. of the display apparatuses.

### SUMMARY

An apparatus for and method of detecting layouts of display apparatuses included in a multi display apparatus are provided.

An apparatus for and method of detecting a connection relationship between display apparatuses included in a multi display apparatus are also provided.

A non-transitory computer-readable recording medium having recorded thereon a computer program for performing the above methods is provided.

Additional aspects will be set forth in the description which follows. Technical goals achieved by the examples set forth in the disclosure are not limited to the described ones and other technical goals may be inferred from the following examples.

According to an example, a detection apparatus for detecting a layout of a multi display apparatus, includes: a controller configured to control the multi display apparatus and an image capturing apparatus arranged so that a plurality of display apparatuses included in the multi display apparatus display an image, wherein the image capturing apparatus is configured to capture an image of the multi display apparatus; and an image analysis unit or circuitry configured to detect a layout of the multi display apparatus based on the image captured by the image capturing apparatus.

According to an example, a detection apparatus for detecting a connection relationship of a multi display apparatus, is configured to: check or set IDs of display apparatuses connected according to a daisy chain method and control the display apparatuses to display images according to an order of the set IDs, and detect the connection relationship of the multi display apparatus based on an image output from an image capturing apparatus configured to capture an image of the multi display apparatus which displays an image based on the order of the set IDs.

According to an example, a method of detecting a layout of a multi display apparatus, includes: displaying an image on the multi display apparatus; capturing an image of the multi display apparatus; and detecting the layout of the multi display apparatus based on the captured image.

### BRIEF DESCRIPTION OF THE DRAWINGS

These and/or other aspects will become apparent from the following description, taken in conjunction with the accompanying drawings in which like reference numerals refer to like elements, and wherein:

FIG. 1 is a diagram illustrating an example layout detection system;

FIG. 2 is a diagram illustrating an example layout detection system;

FIG. 3 is a diagram illustrting an example layout detection system;

FIG. 4 is a diagram illustrating an example layout detection system;

FIG. 5 is a flowchart illustrating an example method of detecting a layout of a multi display apparatus based on a difference image between a current image and a previous image;

FIG. 6 is a flowchart illustrating an example method of detecting a layout of a multi display apparatus based on a difference image between a current image and an initial image;

FIG. 7 is a diagram illustrating checking or setting, by a detection apparatus, IDs of display apparatuses;

FIG. 8 is a diagram illustrating creation of a difference image;

FIG. 9 is a diagram illustrating creation of a difference image;

FIG. 10 is a diagram illustrating an example method of detecting an omitted ID;

FIG. 11 is a diagram illustrating an example method of detecting a duplicate ID;

FIG. 12 is a diagram illustrating an example system for detecting a layout of a multi display apparatus including display apparatuses having different sizes;

FIG. 13 is a diagram illustrating an example system for detecting groups of display apparatuses;

FIG. 14 is a diagram illustrating an example system for detecting layouts of display apparatuses that are arranged by overlapping each other;

FIG. 15 is a diagram illustrating detection of layouts of display apparatuses that are arranged by overlapping each other, based on a difference image;

FIG. 16 is a flowchart illustrating an example system for detecting an entire layout of a multi display apparatus;

FIG. 17 is a diagram illustrating an example system for detecting a connection relationship of a multi display apparatus; and

FIG. 18 is a flowchart illustrating an example system for detecting a connection relationship between and layouts of display apparatuses when the display apparatuses display different images.

### DETAILED DESCRIPTION

The disclosure contemplates various changes and numerous examples, particular examples will be illustrated in the drawings and described in detail in the description. However, the disclosure is not intended to be limited to particular modes of practice, and it is to be appreciated that all changes, equivalents, and substitutes that do not depart from the spirit and technical scope of the disclosure are encompassed in the disclosure. In the description, certain detailed explanations of the related art are omitted when it is deemed that they may unnecessarily obscure the disclosure.

While such terms as “first”, “second”, etc., may be used to describe various components, such components are not to be limited to the above terms. The above terms are used only to distinguish one component from another.

The terms used in the disclosure are merely used to describe particular examples, and are not intended to limit the disclosure. An expression used in the singular encompasses the expression of the plural, unless it has a clearly different meaning in the context. In the disclosure, it is to be understood that the terms such as “including”, “having”, and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Hereinafter, examples will be described in detail by explaining examples of the disclosure with reference to the attached drawings. Like reference numerals in the drawings denote like elements, and their description may be omitted.

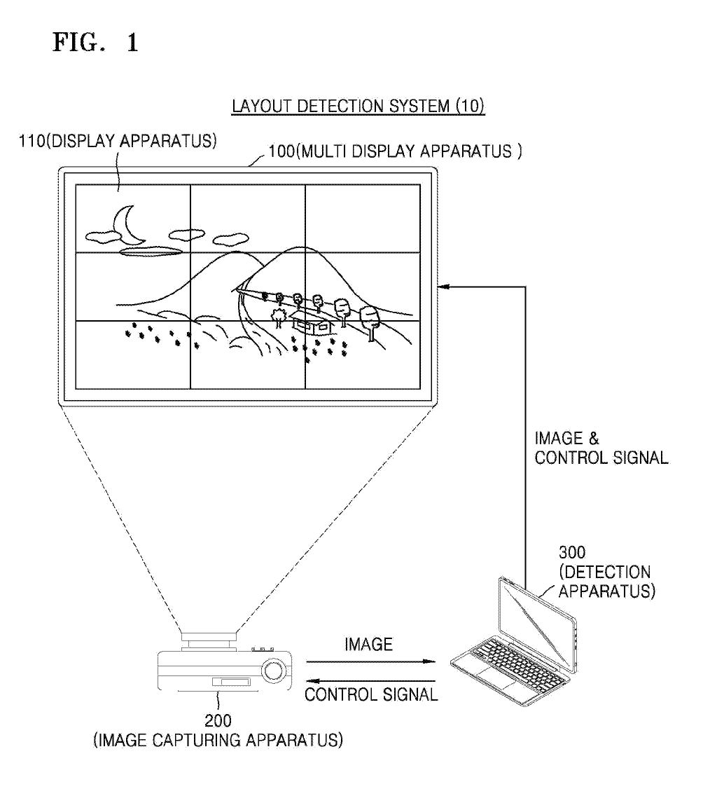

FIG. 1 is a diagram illustrating an example layout detection system 10. Referring to FIG. 1, the layout detection system 10 may include a multi display apparatus 100, an image capturing apparatus 200, and a detection apparatus 300.

The detection apparatus 300 detects coordinates, sizes, locations, and connection relationships of display apparatuses 110 included in the multi display apparatus 100.

The multi display apparatus 100 includes display apparatuses 110. A display apparatus 110 is an apparatus for displaying an image and may display an image based on a control signal of the detection apparatus 300. The display apparatuses 110 may display the same image or different images. The multi display apparatus 100 may, for example, be referred to as multi vision apparatus or a large format display (LFD).

The multi display apparatus 100 displays at least one image. Although the display apparatuses 110 included in the multi display apparatus 100 may display different images, the images displayed on all of the display apparatuses 110 may actually form one image. In other words, each of the display apparatuses 110 may display segmented images, and the segmented images may form a single image.

The image capturing apparatus 200 captures an image of the multi display apparatus 100 and outputs the captured image to the detection apparatus 300. The image capturing apparatus 200 captures an image of the multi display apparatus 100 based on a control signal of the detection apparatus 300. The image capturing apparatus 200 may be positioned outside the multi display apparatus 100. Alternatively, the image capturing apparatus 200 may be positioned either outside or inside the detection apparatus 300.

The image capturing apparatus 200 may be an electronic device capable of capturing an image, for example, a camera, a camcorder, or the like.

The detection apparatus 300 detects a layout of the multi display apparatus 100 based on an image received from the image capturing apparatus 200. The detection apparatus 300 may detect the layout of the multi display apparatus 100 by comparing at least two images. For example, the detection apparatus 300 may change an entire image displayed by the multi display apparatus 100 and detect the layout of the multi display apparatus 100 based on the entire image captured before and after being changed.

For example, the detection apparatus 300 may be configured to control the multi display apparatus 100 to display nothing and controls the image capturing apparatus 200 to capture the image of the multi display apparatus 100, thereby obtaining an image A. Then, the detection apparatus 300 may be configured to control any one of the display apparatuses 110 to display a first image and controls the image capturing apparatus 200 to capture the image of the multi display apparatus 100, thereby obtaining an image B. The detection apparatus 300 determines a difference image between the images A and B and detects a layout of the display apparatus 110 that displays the first image based on the difference image.

The detection apparatus 300 repeats the above processes for all of the display apparatuses 110 and may detect layouts thereof. A method of detecting, by the detection apparatus 300, the layout of the multi display apparatus 100 will be described below with reference to other drawings.

The detection apparatus 300 controls the multi display apparatus 100 and the image capturing apparatus 200. The detection apparatus 300 changes an image displayed by the multi display apparatus 100 and controls the image capturing apparatus 200 to capture the changed image. For example, the detection apparatus 300 may change types of the image displayed by the multi display apparatus 100 or may change a display apparatus 110 that displays the image. For example, the detection apparatus 300 may control the multi display apparatus 100 such that some of the display apparatuses 110 included in the multi display apparatus 100 may display an image. The detection apparatus 300 may set or check an ID of each display apparatus 110 and may detect which of the display apparatuses 110 having a certain ID displays an image. Accordingly, the detection apparatus 300 may identify whether the display apparatus 110 having the certain ID has the detected layout. The detection apparatus 300 controls the image capturing apparatus 200 to capture an image and receives the image captured by the image capturing apparatus 200. The detection apparatus 300 may, for example, capture an image of the multi display apparatus 100 by controlling the image capturing apparatus 200 whenever an image displayed by the multi display apparatus 100 is changed.

The detection apparatus 300 may, for example, be a laptop computer, a tablet personal computer (PC), a mobile device, or the like.

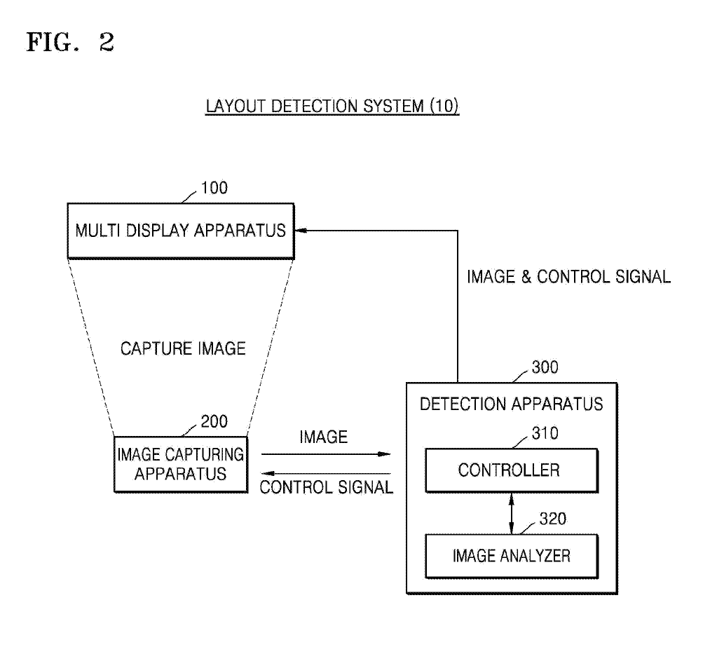

FIG. 2 is a diagram illustrating an example layout detection system. Referring to FIG. 2, the detection apparatus 300 may include a controller 310 and an image analysis unit or image analyzer 320.

The controller 310 may be configured to control the multi display apparatus 100. The controller 310 may be configured to transmit control signals to the display apparatuses 110 such that the display apparatuses 110 display images. The controller 310 may be configured to check or set IDs of the display apparatuses 110. The controller 310 may be configured to check the IDs of the display apparatuses 110 that are set in advance, and if the IDs are not set, new IDs may be respectively set for the display apparatuses 110. The ID may, for example, include information for distinguishing the display apparatuses 110. For example, the ID may be a number assigned to each display apparatus 110. Also, the ID may be an Internet protocol (IP), a MAC address, etc. In addition, the ID may be a certain character or the like defined by a user.

The image analyzer 320 is configured to create a difference image of a received image and to detect a layout the multi display apparatus 100 by analyzing the difference image. The image analyzer 320 receives images from the image capturing apparatus 200 and creates a difference image between two images. For example, a difference image between an image A and an image B may be an image only showing a difference between the image A and the image B. The image analyzer 320 may detect a layout of each display apparatus 110 based on information displayed in the difference image. Also, the image analyzer 320 may detect an entire layout of the multi display apparatus 100. For example, the image analyzer 320 may detect layouts of the display apparatuses 110 by checking a form, size, location, etc. of a shape included in the difference image.

The controller 310 and the image analyzer 320 may, for example, be embodied by at least one processor.

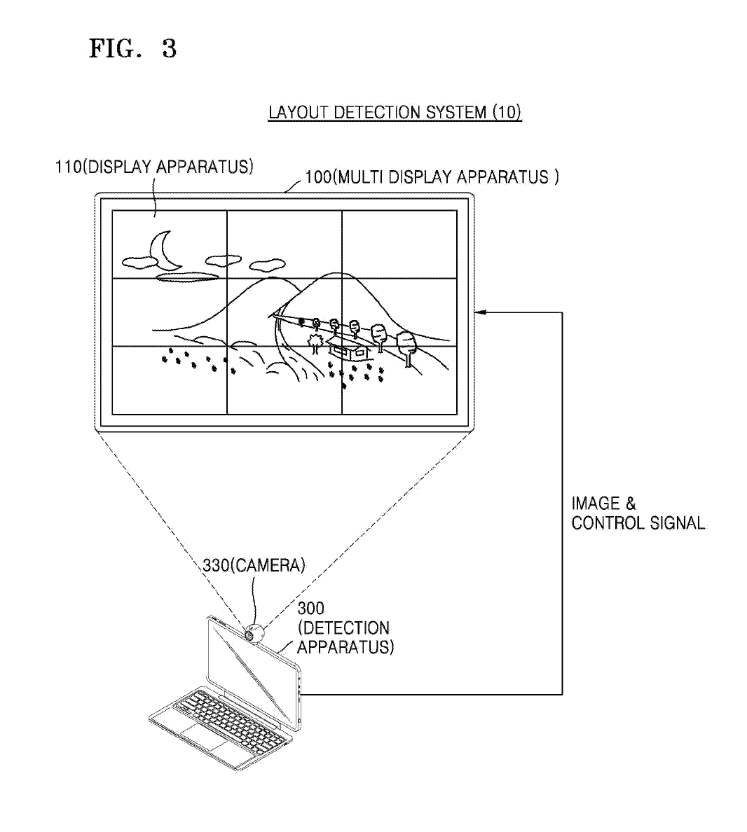

FIG. 3 is a diagram illustrating an example layout detection system. Referring to FIG. 3, the detection apparatus 300 may include a camera 330. Therefore, the detection apparatus 300 may obtain an image of the multi display apparatus 100 without a separate image capturing apparatus 200.

Since the detection apparatus 300 includes the camera 330, the layout detection system 10 of FIG. 3 does not require the image capturing apparatus 200, but is otherwise the same as the layout detection system 10 of FIGS. 1 and 2. That is, functions performed by the image capturing apparatus 200 of FIGS. 1 and 2 are performed by the camera 330 of FIG. 3. Therefore, the descriptions provided with reference to FIGS. 1 and 2 may be applied to the layout detection system 10 of FIG. 3.

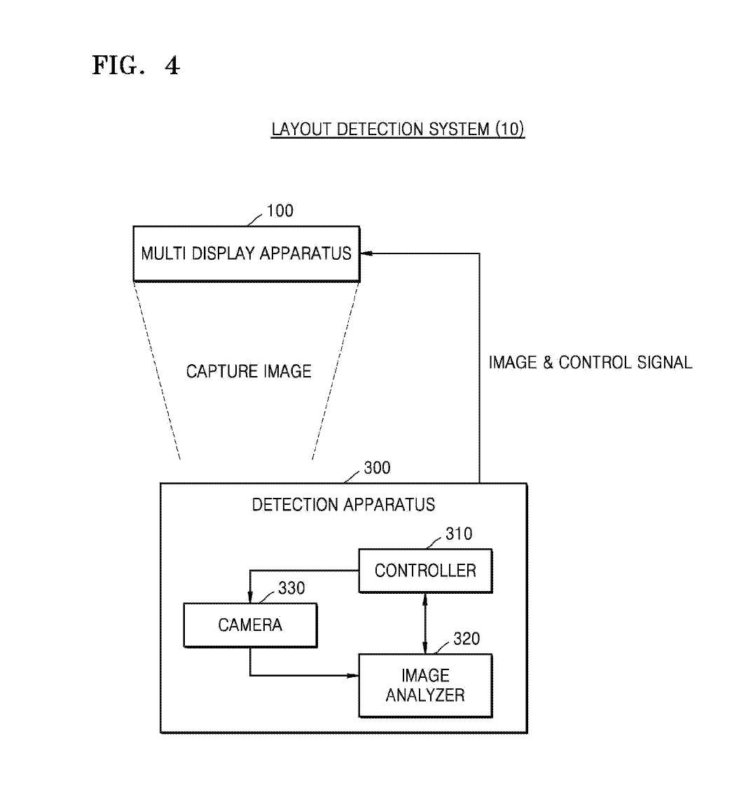

FIG. 4 is a diagram illustrating an example layout detection system. Referring to FIG. 4, the detection apparatus 300 of FIG. 4 further includes the camera 330 in comparison with the detection apparatus 300 of FIG. 2. The camera 330 is included in the detection apparatus 300 and captures an image of the multi display apparatus 100. The detection apparatus 300 may detect a layout of the multi display apparatus 100 based on images captured by the camera 330. The controller 310 may be configured to control the camera 330, and the camera 330 outputs the captured images to the image analyzer 320.

FIG. 4 is a structural diagram illustrating the layout detection system 10 of FIG. 3, and thus descriptions of the layout detection system 10 provided with reference to FIG. 3 may be applied to the layout detection system 10 of FIG. 4.

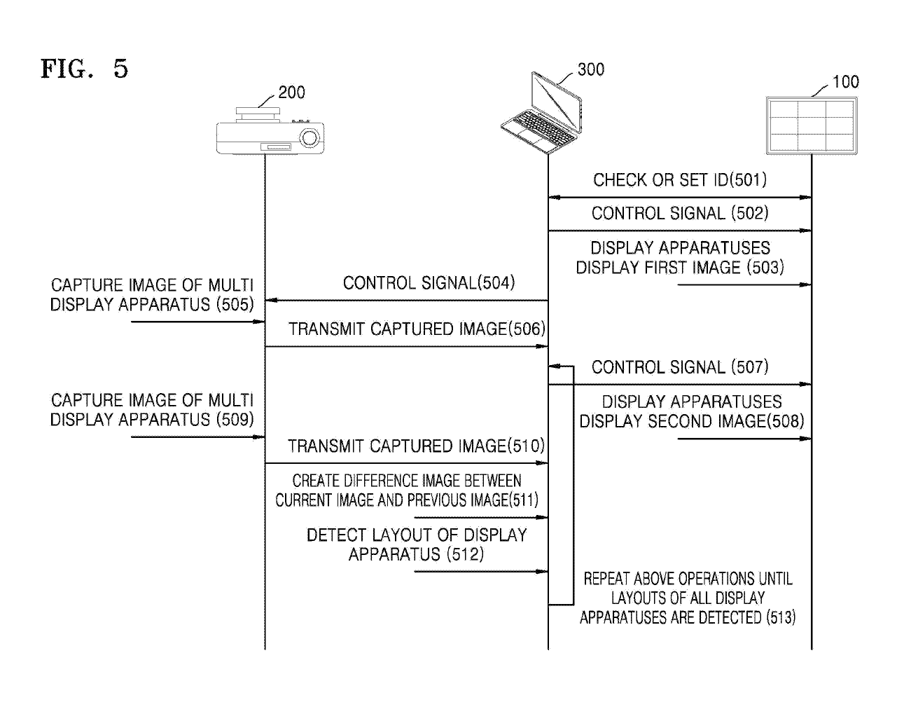

FIG. 5 is a flowchart illustrating an example method of detecting a layout of the multi display apparatus 100 based on a difference image between a current image and a previous image.

In operation 501, the detection apparatus 300 checks or sets IDs of the display apparatuses 110. The detection apparatus 300 checks or sets the IDs to determine which of the display apparatuses 110 displays an image.

In operation 502, the detection apparatus 300 transmits a control signal to the multi display apparatus 100 such that the multi display apparatus 100 displays a first image. For example, the first image may be an arbitrary image or a black image.

In operation 503, all of the display apparatuses 110 included in the multi display apparatus 100 display the first image.

In operation 504, the detection apparatus 300 outputs a control signal to the image capturing apparatus 200 in order to capture an image of the multi display apparatus 100.

In operation 505, the image capturing apparatus 200 captures the image of the multi display apparatus 100. The image capturing apparatus 200 may be positioned at a location where the entire multi display apparatus 100 may be captured. The image capturing apparatus 200 captures the image of the multi display apparatus 100 when all of the display apparatuses 110 display the first image.

In operation 506, the image capturing apparatus 200 transmits the captured image to the detection apparatus 300.

In operation 507, after receiving the image, the detection apparatus 300 outputs a control signal to the multi display apparatus 100 such that the display apparatuses 110 sequentially display a second image. For example, the second image may be an arbitrary image or a white image. The control signal may include an ID of the display apparatus 110 that is to display the second image.

The display apparatus 110 that is to display the second image is determined, based on the ID. For example, the detection apparatus 300 determines an order of the display apparatuses 110 by referring to the ID and controls the display apparatuses 110 to display the second image based on the determined order. For example, the display apparatus 110 having an ID of 1 displays the second image, and then the display apparatuses 110 having IDs of 1 and 2 display the second image. Then the display apparatuses 110 having IDs of 1 to 3 may display the second image. Lastly, all of the display apparatuses 110 having IDs of 1 to the last number may display the second image. In other words, all of the display apparatuses 110 display the second image.

In operation 508, at least one display apparatus 110 displays the second image. The display apparatus 110 that is to display the second image is determined based on the control signal transmitted by the detection apparatus 300.

In operation 509, the image capturing apparatus 200 captures the image of the multi display apparatus 100. Although not illustrated in drawings, the image capturing apparatus 200 operates under the control of the detection apparatus 300. The image capturing apparatus 200 captures the image of the multi display apparatus 100 whenever the display apparatus 110 that displays the second image is changed based on the control of the detection apparatus 300.

In operation 510, the image capturing apparatus 200 transmits the captured image to the detection apparatus 300.

In operation 511, the detection apparatus 300 creates a difference image between a current image and a previous image. The current image is, for example, an image captured when the first to n^{th} display apparatuses 110 display the second image, and the previous image is an image captured when the first to n−1^{th} display apparatuses 110 display the second image. If the current image is an image captured when only the first display apparatus 110 displays the second image, the previous image is an image captured when all of the display apparatuses 110 display the first image.

In operation 512, the detection apparatus 300 detects a layout of the n^{th} display apparatus 110. In the case of the current image and the previous image, the detection apparatus 300 may detect the layout of the n^{th} display apparatus 110 based on the difference image because the n^{th} display apparatus 110 may display or may not display the second image.

In operation 513, the detection apparatus 300 repeatedly performs operations 507 to 512. The detection apparatus 300 repeats operations 507 to 512 until layouts of all of the display apparatuses 110 are detected. For example, the detection apparatus 300 captures the image of the multi display apparatus 100 by controlling the display apparatuses 110 to sequentially display the second image, and a layout of the display apparatus 110 that most recently displays the second image is detected.

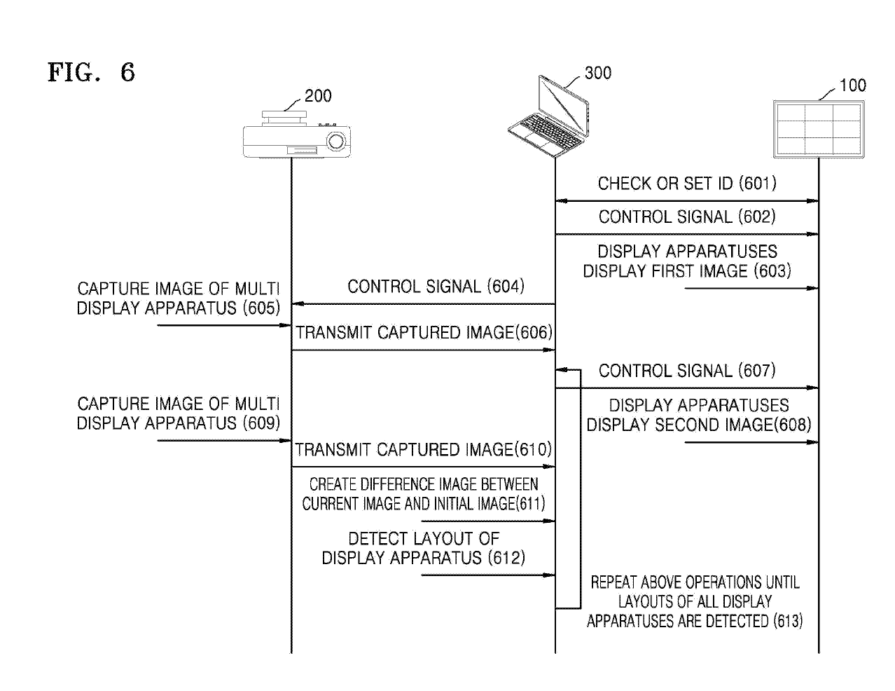

FIG. 6 is a flowchart illustrating an example method of detecting a layout of the multi display apparatus 100 based on a difference image between a current image and an initial image. Referring to FIG. 6, the detection apparatus 300 may detect the layout of the multi display apparatus 100 based on the difference image between the current image and the initial image.

In operation 601, the detection apparatus 300 checks or sets IDs of the display apparatuses 110. The detection apparatus 300 checks or sets the IDs in order to determine which of the display apparatuses 110 is to display an image.

In operation 602, the detection apparatus 300 transmits a control signal to the multi display apparatus 100 such that all of the display apparatuses 110 display the first or initial image. For example, the first image may be an arbitrary image or a black image.

In operation 603, all of the display apparatuses 110 included in the multi display apparatus 100 display the first image.

In operation 604, the detection apparatus 300 transmits a control signal to the image capturing apparatus 200 to capture the image of the multi display apparatus 100.

In operation 605, the image capturing apparatus 200 captures the image of the multi display apparatus 100. The image capturing apparatus 200 is positioned at a location where the image of the entire multi display apparatus 100 may be captured. The image capturing apparatus 200 captures a state in which the multi display apparatus 100 is displaying the first image.

In operation 606, the image capturing apparatus 200 transmits the captured image to the detection apparatus 300.

In operation 607, after receiving the image from the image capturing apparatus 200, the detection apparatus 300 outputs a control signal to the multi display apparatus 100 such that a selected display apparatus 110 displays the second image. In other words, the detection apparatus 300 controls the multi display apparatus 100 such that at least one of the display apparatuses 110 displays the second image. The second image may be an arbitrary image or a white image.

In operation 608, the selected display apparatus 110 displays the second image.

In operation 609, the image capturing apparatus 200 captures the image of the multi display apparatus 100 under the control of the detection apparatus 300.

In operation 610, the image capturing apparatus 200 transmits the captured image to the detection apparatus 300.

In operation 611, the detection apparatus 300 creates a difference image between a current image and an initial image. The current image is an image captured when the display apparatus 110, which is selected by the detection apparatus 300, displays the second image, and the initial image is an image captured when all of the display apparatuses 110 display the first image. The detection apparatus 300 creates a difference image showing a portion of the current image that is different from the initial image.

In operation 612, the detection apparatus 300 detects a layout of the selected display apparatus 110. In the case of the current image and the initial image, the detection apparatus 300 may detect the layout of the selected display apparatus 110 based on the difference image because the selected display apparatus 110 may display or may not display the second image.

In operation 613, the detection apparatus 300 repeatedly performs operations 607 to 612. The detection apparatus 300 repeatedly performs operations 607 to 612 until layouts of all of the display apparatuses 110 are detected.

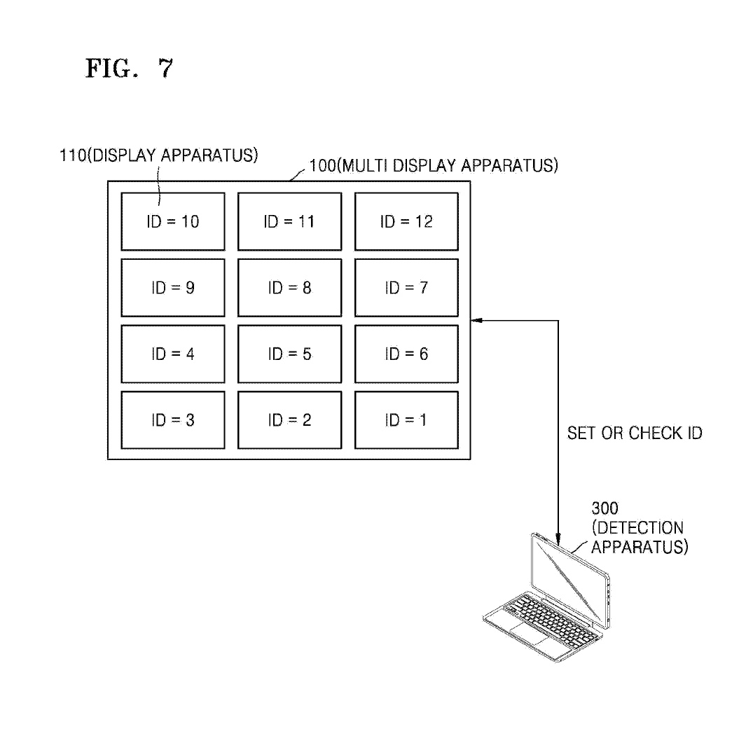

FIG. 7 is a diagram illustrating checking or setting IDs of the display apparatuses 110, by the detection apparatus 300. Referring to FIG. 7, the detection apparatus 300 may set the IDs of the display apparatuses 110 or check the set IDs. FIG. 7 illustrates an example where the IDs are numbers. FIG. 7 illustrates that IDs of twelve display apparatus are, for example, set to 1 to 12.

The detection apparatus 300 sets different IDs for the display apparatuses 110. The detection apparatus 300 may sequentially or randomly set the IDs based on an order in which the display apparatuses 110 are connected to each other.

The detection apparatus 300 checks the IDs of the display apparatuses 110. Unique IPs, MAC addresses, etc. may be set for the display apparatuses 110, and the detection apparatus 300 may detect the display apparatuses 110 using the unique IPs and the MAC addresses.

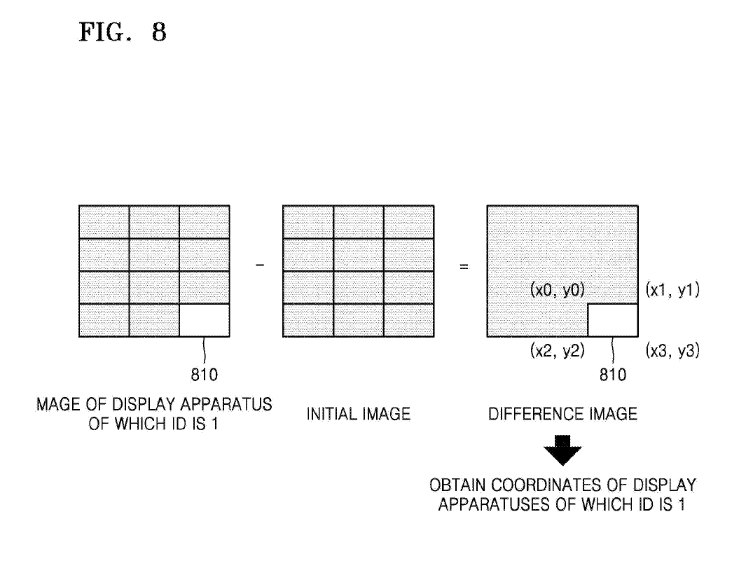

FIG. 8 is a diagram illustrating an example creation of a difference image. Also, FIG. 8 illustrates a process of detecting a layout of a first display apparatus 810 based on a difference image.

The detection apparatus 300 detects the layout of the first display apparatus 810 having an ID of 1 based on a difference image between an initial image and an image of the first display apparatus 810. The image of the first display apparatus 810 having an ID of 1 is an image captured when the first display apparatus 810 is displayed. The initial image is captured when all of the display apparatuses 110 display nothing or display a black image. The difference image shows a portion of the image of the first display apparatus 810 which is different from the initial image. The difference image includes a layout of the first display apparatus 810 having an ID of 1. Therefore, the detection apparatus 300 may, for example, obtain coordinates of the first display apparatus 810 from the difference image, and the coordinates may be (x0, y0), (x1, y1), (x2, y2), and (x3, y3). Also, the detection apparatus 300 may also obtain a shape, size, or the like of the first display apparatus 810 from the difference image.

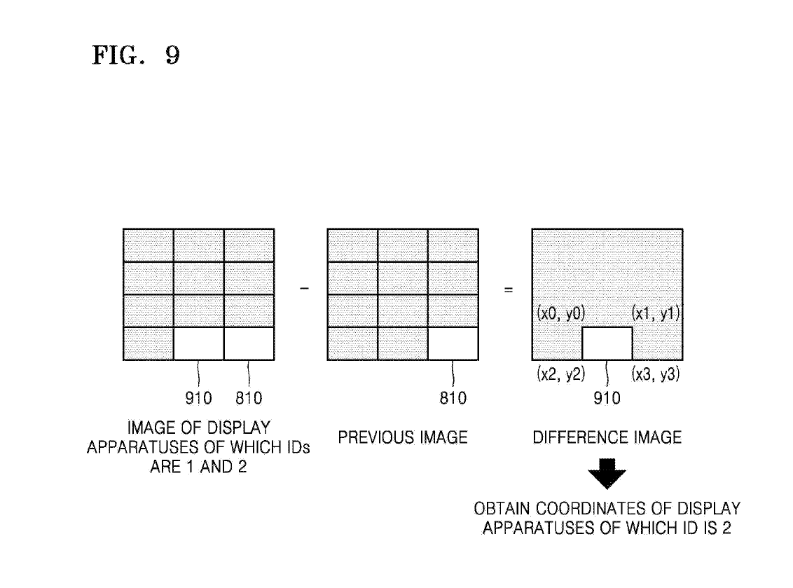

FIG. 9 is a diagram illustrating an example creation of a difference image. FIG. 9 illustrates a process of detecting a layout of a second display apparatus 910.

The detection apparatus 300 detects the layout of the second display apparatus 910 having an ID of 2 based on a difference image between a previous image and images of the first and second display apparatuses 810 and 910 of having IDs of 1 and 2, respectively. The images of the first and second display apparatuses 810 and 910 are captured when only the first and second display apparatuses 810 and 910 display images. The previous image is captured when the first display apparatus 810 displays an image. The difference image is an image only showing the second display apparatus 910 having an ID of 2. Therefore, the detection apparatus 300 may obtain coordinates of the second display apparatus 910 from the difference image. Also, the detection apparatus 300 may obtain a shape, size, etc. of the second display apparatus 910 having an ID of 2, from the difference image.

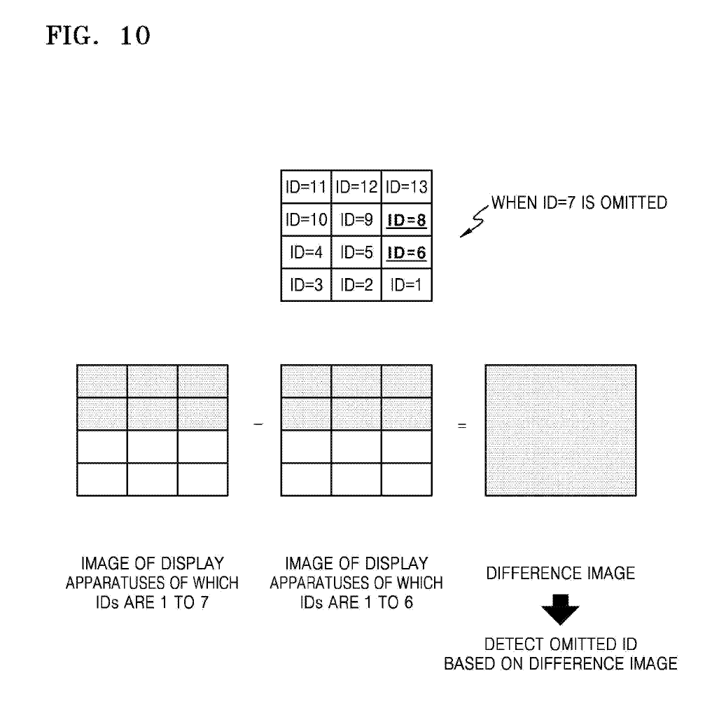

FIG. 10 is a diagram illustrating an example method of detecting an omitted ID. Referring to FIG. 10, the detection apparatus 300 may detect an omitted ID from among the IDs that are set for the display apparatuses 110. For example, FIG. 10 illustrates casein example where an ID=7 is omitted, and the detection apparatus 300 may detect the omitted ID.

When the ID=7 is omitted, no mark is detected from a difference image. Therefore, the detection apparatus 300 may detect the omitted ID based on the difference image.

Since there is no display apparatus 110 having an ID of 7, images of the display apparatuses 110 having IDs of 1 to 7 are the same as those of display apparatuses 110 having IDs of 1 to 6. Therefore, nothing is shown in the difference image between the current image and the previous image, and the detection apparatus 300 may detect that there is no display apparatus 110 having an ID of 7.

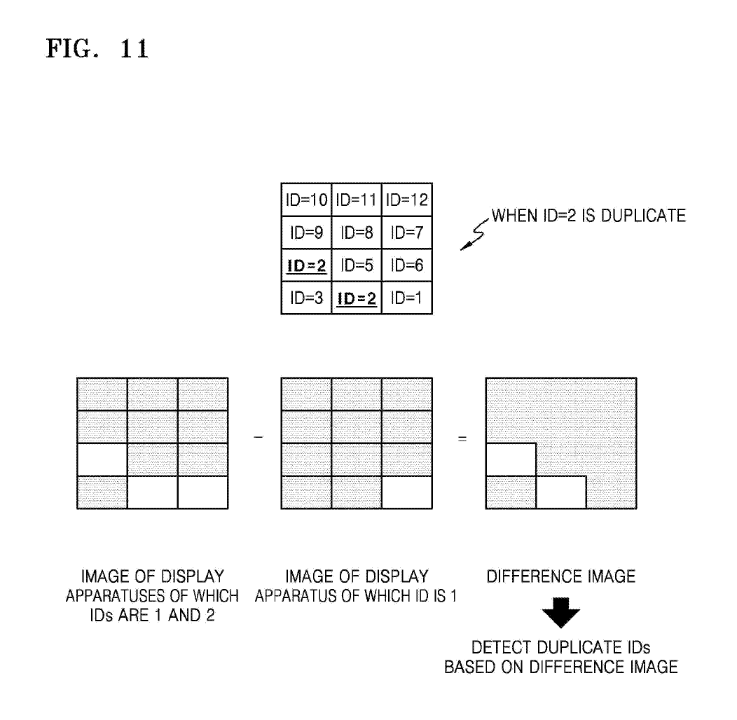

FIG. 11 is a diagram illustrating an example method of detecting a duplicate ID. Referring to FIG. 11, the detection apparatus 300 may detect a duplicate ID from among the IDs set for the display apparatuses 110. For example, FIG. 11 illustrates a case where ID=2 is duplicate and the detection apparatus 300 may detect the duplicate ID.

When the ID=2 is duplicate, an area marked on a difference image is two times larger than an area marked on a previous difference image. Therefore, the detection apparatus 300 may detect the duplicate ID via the area marked on the difference image. Also, when rectangular areas are detected at two or more locations of the difference image, the detection apparatus 300 may determine that the IDs are duplicate. The rectangular areas are ordinary shapes of the display apparatuses 110, and if the display apparatuses 110 have different shapes, areas having different shapes may be detected at two or more locations of the difference image.

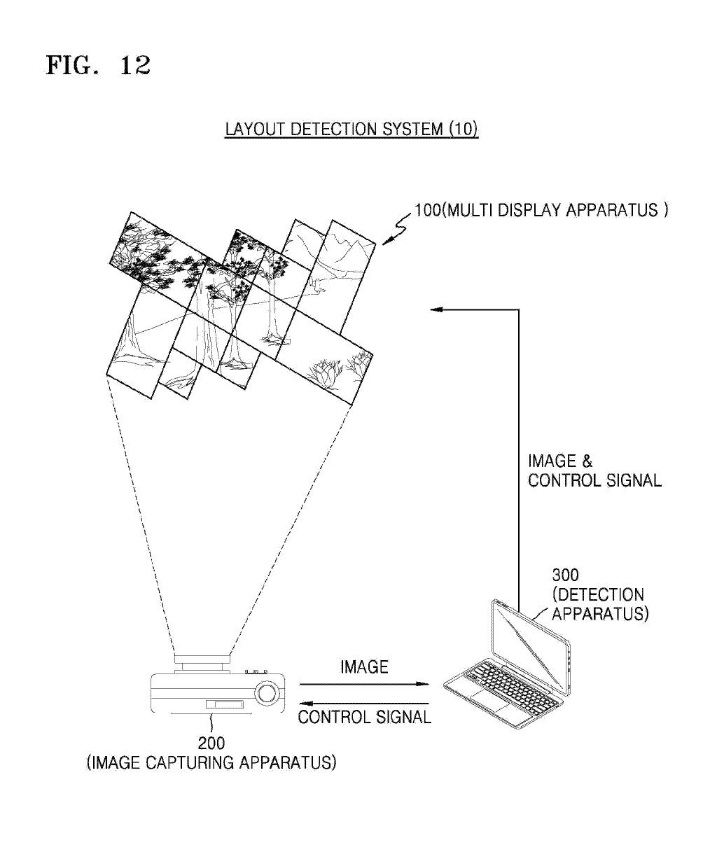

FIG. 12 is a diagram illustrating an example system for detecting a layout of the multi display apparatus 100 including the display apparatuses 110 having different sizes.

Referring to FIG. 12, the detection apparatus 300 may detect layouts of the display apparatuses 110 having different sizes.

The multi display apparatus 100 of FIG. 12 includes display apparatuses 110 having different sizes, and the detection apparatus 300 may detect a layout of each display apparatus 110 and an entire layout of all of the display apparatuses 110.

The detection apparatus 300 may, for example, detect the layout of each display apparatus 110 based on images of the display apparatuses 110 that are sequentially captured.

The detection apparatus 300 detects the layouts of all of the display apparatuses 110 based on a difference image between an image, which is captured when all of the display apparatuses 110 display nothing or a first image, and an image captured when all of the display apparatuses 110 display the second image.

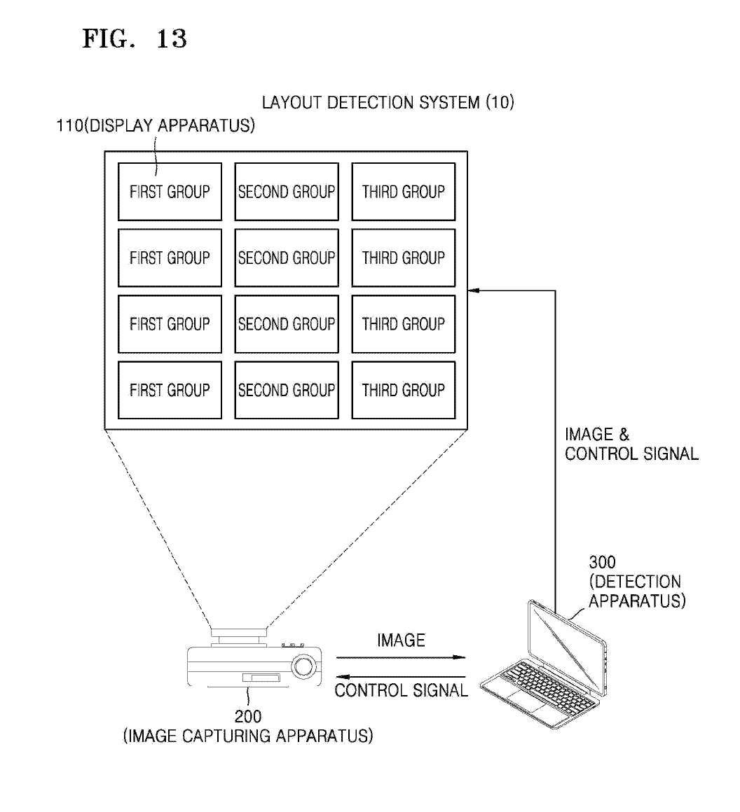

FIG. 13 is a diagram illustrating an example system for detecting groups of the display apparatuses 110. Referring to FIG. 13, the detection apparatus 300 may classify the groups of the display apparatuses 110.

The display apparatuses 110 may be classified into at least two groups. FIG. 13 illustrates that the display apparatuses 110 are classified into first to third groups. The display apparatuses 110 that are in the same group may display a whole image. For example, the display apparatuses 110 that are in the same group individually display images, but the individual images may form a whole image. The first to third groups may display different whole images. For example, the display apparatuses 110 in the first group display an information image, the display apparatuses 110 in the second group display an advertisement image, and the display apparatuses 110 in the third group display a music video.

The detection apparatus 300 controls the multi display apparatus 100 to display images per group. For example, a case where the detection apparatus 300 detects a layout of the display apparatuses 110 in the third group will be described. The detection apparatus 300 may control the display apparatuses 110 in all groups to display the first image or nothing and controls the image capturing apparatus 200 to capture an image of the multi display apparatus 100. Then, the detection apparatus 300 may control the display apparatuses 110 in the first and second groups to display the first image or nothing and controls the display apparatuses 110 in the third group to display the second image. The detection apparatus 300 controls the image capturing apparatus 200 to capture the image of the multi display apparatus 100. The detection apparatus 300 detects layouts of the display apparatuses 110 in the third group by obtaining a difference image between two captured images. In the same way, the detection apparatus 300 detects layouts of the display apparatuses 110 in the first and second groups.

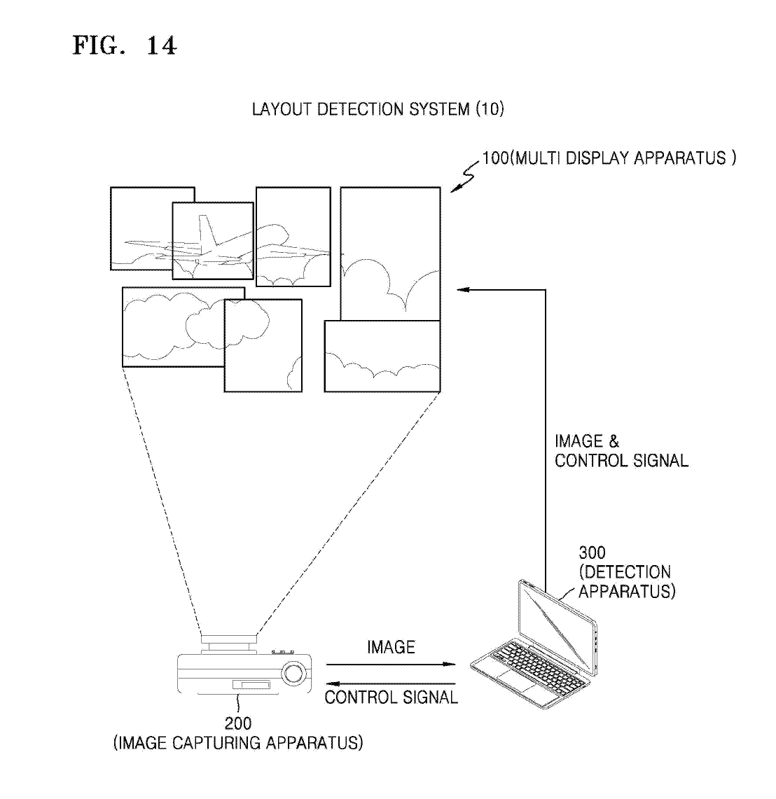

FIG. 14 is a diagram illustrating an example system for detecting layouts of display apparatuses that are arranged by overlapping each other. The detection apparatus 300 may detect the layouts of display apparatuses that are arranged overlapping with each other. When the display apparatuses 110 overlap each other, any of the display apparatuses 110 may be covered by other display apparatuses 110 so that a portion of a displayed image may not be visible.

The detection apparatus 300 detects a shape of a polygon included in a difference image, instead of a shape of a rectangle, and thus may detect that there are display apparatuses 110 overlapping each other. Through the same way as described above, the detection apparatus 300 obtains a difference image with regard to each display apparatus 110. When a polygon (other than a rectangle) is included in the difference image instead of a rectangle, the detection apparatus 300 may detect that there are display apparatuses 110 overlapping each other. For example, when a shape different from a shape of the display apparatus 110 is detected from the difference image, the detection apparatus 300 may detect that there are display apparatuses 110 overlapping each other. The detection apparatus 300 may determine that a display apparatus 110 having a polygonal shape not a rectangular shape is covered by other display apparatuses 110. Also, the detection apparatus 300 may determine which of the display apparatuses 110 is positioned in front of other display apparatuses 110 based on locations, sizes, etc. of the display apparatuses 110 and may check IDs of the display apparatuses 110 overlapping each other.

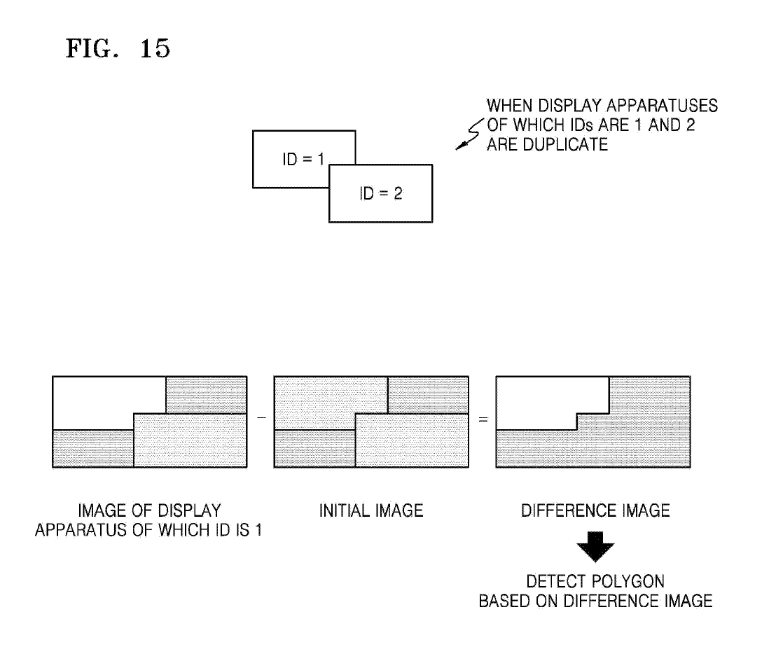

FIG. 15 is a diagram illustrating an example detection of layouts of the display apparatuses 110 that are arranged overlapping each other, based on a difference image. FIG. 15 illustrates an example where display apparatuses 110 having IDs of 1 and 2 overlap each other.

The detection apparatus 300 obtains an initial image and an image of the display apparatus 110 having an ID of 1 and then obtains a difference image between the initial image and the image of the display apparatus 110 having an ID of 1. The image of the display apparatus 110 is captured when only the display apparatus 110 having an ID of 1 displays an image, and the initial image is captured when all of the display apparatuses 110 display nothing.

Referring to the difference image of FIG. 15, the display apparatus 110 has, for example, a hexagonal shape, instead of a rectangular shape. That is, since the display apparatus 110 having an ID of 1 is partially covered by the display apparatus 110 having an ID of 2, it is detected that the display apparatus 110 having ID of 1 has a hexagonal (or six-sided) shape, instead of its original shape. Therefore, the detection apparatus 300 may check that the display apparatus 110 having an ID of 1 is partially covered by the display apparatus 110 having an ID of 2.

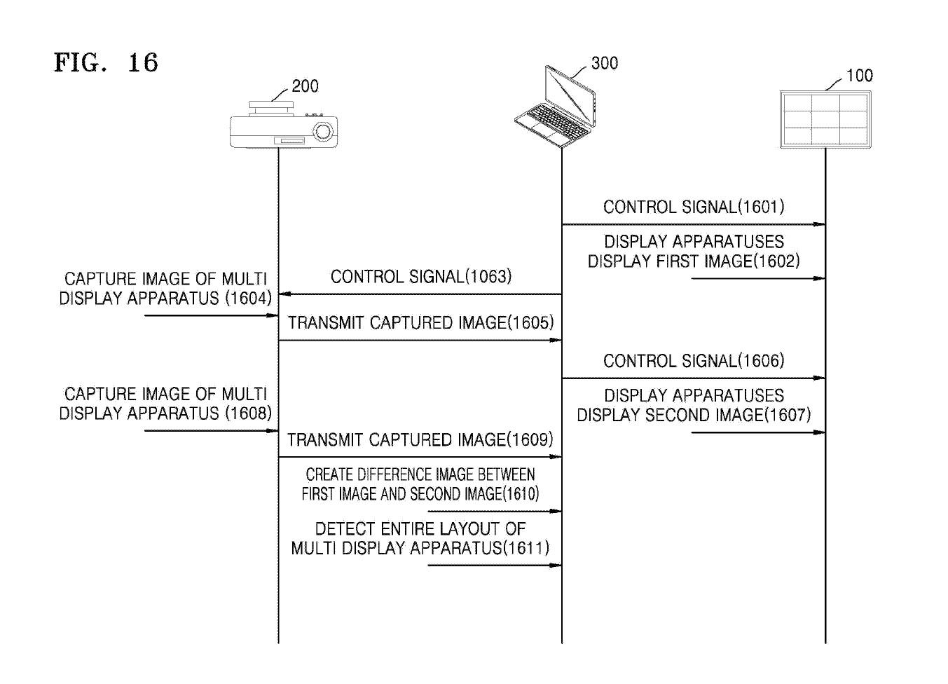

FIG. 16 is a flowchart illustrating an example system for detecting an entire layout of the multi display apparatus 100.

In operation 1601, the detection apparatus 300 transmits a control signal to the multi display apparatus 100 to display a first image. For example, the first image may be an arbitrary image or a black image.

In operation 1602, all of the display apparatuses 110 included in the multi display apparatus 100 display the first image.

In operation 1603, the detection apparatus 300 outputs a control signal to the image capturing apparatus 200 to capture an image of the multi display apparatus 100.

In operation 1604, the image capturing apparatus 200 captures the image of the multi display apparatus 100.

In operation 1605, the image capturing apparatus 200 transmits the captured image to the detection apparatus 300.

In operation 1606, the detection apparatus 300 outputs a control signal to the multi display apparatus 100 such that all of the display apparatuses 110 display a second image. For example, the second image may be an arbitrary image or a white image.

In operation 1607, all of the display apparatuses 110 display the second image.

In operation 1608, the image capturing apparatus 200 captures the image of the multi display apparatus 100 under the control of the detection apparatus 300.

In operation 1609, the image capturing apparatus 200 transmits the captured image to the detection apparatus 300.

In operation 1610, the detection apparatus 300 creates a difference image between an image of the multi display apparatus 100 that displays the first image and an image of the multi display apparatus 100 that displays the second image.

In operation 1611, the detection apparatus 300 may detect an entire layout of the multi display apparatus 100 based on the difference image. In the difference image, no mark is indicated on an outer area of the multi display apparatus 100, and a difference between the first image and the second image is only indicated on an internal area of the multi display apparatus 100. For example, in the image of the multi display apparatus 100 displaying the first image and the image of the multi display apparatus 100 displaying the second image, outer areas of the multi display apparatus 100 are the same as each other, and thus, the difference image is blank.

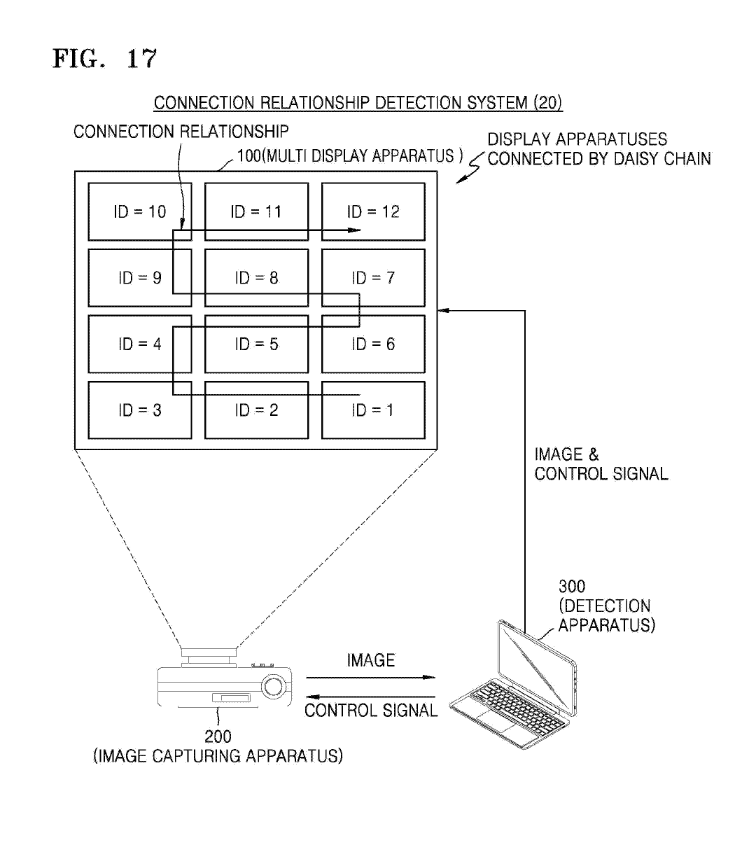

FIG. 17 is a diagram illustrating an example system for detecting a connection relationship of the multi display apparatus 100. Referring to a connection relationship detection system 20 of FIG. 17, how the detection apparatus 300 is connected to the display apparatuses 110 may be determined.

The detection apparatus 300 detects a connection relationship between the display apparatuses 110 that are connected to one another according to, for example, a daisy chain method. The daisy chain method may be one in which the display apparatuses 110 are connected in series to one another. For example, the display apparatuses 110 that are connected according to the daisy chain method are connected to adjacent display apparatuses 110 and may sequentially transmit an image or control signal.

FIG. 17 illustrates that the display apparatuses 110 having IDs of 1 to 12 are connected according to the daisy chain method. An arrow above the multi display apparatus 100 shows a connection relationship between the display apparatuses 110. For example, the display apparatuses 110 having IDs of 1 to 12 are connected to one another according to an order of the IDs. FIG. 17 illustrates a rectangular multi display apparatus 100, but a shape and connection relationship of the multi display apparatus 100 are not limited thereto.

The detection apparatus 300 may detect the connection relationship between the display apparatuses 110 connected according to the daisy chain method. The detection apparatus 300 may detect that the display apparatuses 110 are connected according to the order of the IDs, but may not detect relative locations of the display apparatuses 110. Therefore, it is necessary for the detection apparatus 300 to detect an installation location of each display apparatus 110.

The detection apparatus 300 controls the display apparatuses 110 to display images and controls the multi display apparatus 100 and the image capturing apparatus 200 to capture images based on the order of the IDs. The detection apparatus 300 sets the IDs based on an order in which the display apparatuses 110 are connected and controls the display apparatuses 110 to display images based on the order of the IDs. For example, displaying, by the display apparatuses 110, the images based on the order of the IDs may indicate that the display apparatus 110 having an ID of 1 displays the second image, the display apparatuses 110 having IDs 1 and 2 display the second image, and then the display apparatuses 110 having IDs 1 to 3 display the second image. Lastly, the display apparatuses 110 having IDs 1 to 12 display the second image. In this case, the detection apparatus 300 obtains a difference image that is created by excluding, from a current image that is always captured, a previous image that is most recently captured.

As another example, the display apparatuses 110 may respectively display the second image. For example, the display apparatus 110 having an ID of 1 may only display the second image, the display apparatus 110 having an ID of 2 may only display the second image, and the display apparatus 110 having an ID of 3 may only display the second image. Lastly, the display apparatus 110 having an ID of 12 may only display the second image. In this case, the detection apparatus 300 obtains a difference image that is created by excluding an initial image from the current image that is always captured. The initial image may be an image captured when all of the display apparatuses 110 display the first image or nothing.

In FIG. 17, a display apparatus 110 positioned on a lower right side of the multi display apparatus 100 is a first display apparatus 110 that is connected to the detection apparatus 300 at first, and thus, the detection apparatus 300 sets an ID of the first display apparatus 110 to 1. In a similar manner, the detection apparatus 300 sets IDs of twelve display apparatuses 110 to 1 to 12.

The detection apparatus 300 controls the image capturing apparatus 200 to capture an image of the display apparatuses 110 that display the images based on the order of the IDs and detects the connection relationship between the display apparatuses 110 having IDs 1 to 12 based on the captured image. For example, the detection apparatus 300 may check that the display apparatus 110 having an ID of 4 is positioned above the display apparatus 110 having an ID of 3 and that the display apparatus 110 having an ID of 6 is positioned at the right of the display apparatus 110 having an ID of 5.

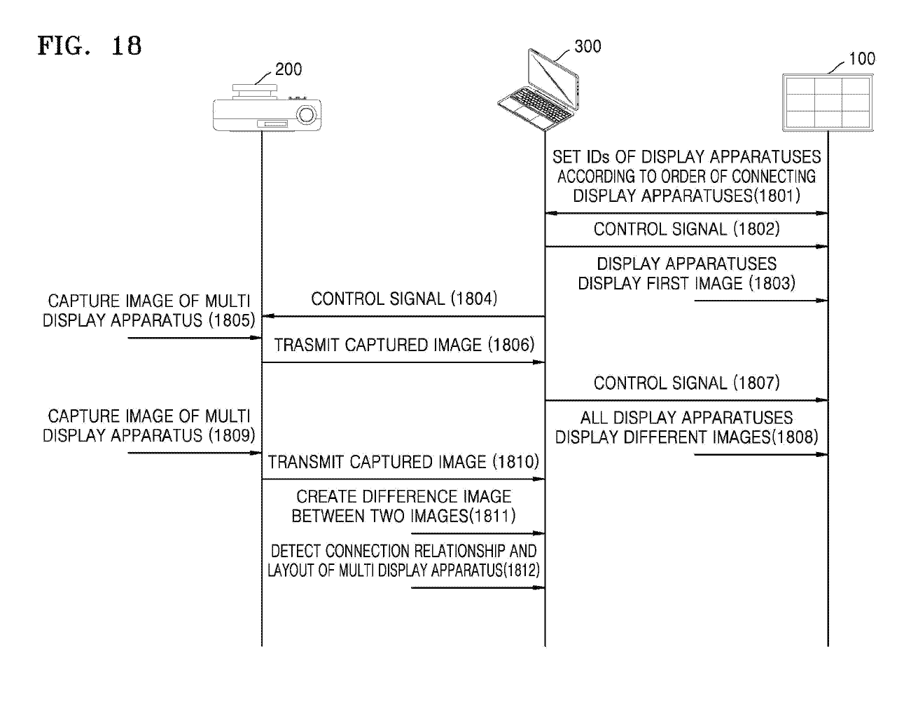

FIG. 18 is a flowchart illustrating an example system for detecting a connection relationship between and layouts of display apparatuses 110 when the display apparatuses display different images. The detection apparatus 300 may detect the layouts of and connection relationship between the display apparatuses 110 based on images respectively displayed by the display apparatuses 110.

In operation 1801, the detection apparatus 300 sets IDs of the display apparatuses 110 based on a connection order of the display apparatuses 110. The display apparatuses 110 are connected to one another according to, for example, a daisy chain method.

In operation 1802, the detection apparatus 300 transmits a control signal to the multi display apparatus 100 such that all of the display apparatuses 110 may output a first image. For example, the first image may be a black image. As another example, the detection apparatus 300 may control the display apparatuses 110 to display nothing.

In operation 1803, all of the display apparatuses 110 display the first image.

In operation 1804, the detection apparatus 300 transmits a control signal to the image capturing apparatus 200 such that the image capturing apparatus 200 may capture an image of the multi display apparatus 100.

In operation 1805, the image capturing apparatus 200 captures the image of the multi display apparatus 100.

In operation 1806, the image capturing apparatus 200 transmits the captured image to the detection apparatus 300.

In operation 1807, the detection apparatus 300 transmits a control signal to all of the display apparatuses 110 such that the display apparatuses 110 display different images. The detection apparatus 300 determines an image based on IDs of the display apparatuses 110 and transmits the determined image to the multi display apparatus 100. Therefore, the detection apparatus 300 may predict which of the display apparatuses 110 displays which image.

In operation 1808, the display apparatuses 110 display different images.

The multi display apparatus 100 receives an image from the detection apparatus 300 based on the IDs, and the display apparatuses 110 that are sequentially connected display designated images.

In operation 1809, the image capturing apparatus 200 receives a control signal from the detection apparatus 300 and captures the image of the multi display apparatus 100 based on the control signal.

In operation 1810, the image capturing apparatus 200 transmits the captured image to the detection apparatus 300.

In operation 1811, the detection apparatus 300 creates a difference image between two captured images. The detection apparatus 300 creates a difference image by excluding an image, which is captured when the display apparatuses 110 display the first image, from images captured when the display apparatuses 110 display different images.

In operation 1812, the detection apparatus 300 detects a connection relationship and layout of the multi display apparatus 100 based on the difference image. The detection apparatus 300 may detect the relationship and layout by comparing the captured image and the image transmitted to the multi display apparatus 100 in operation 1807. For example, if the detection apparatus 300 transmits the control signal in operation 1807 to allow the display apparatus having an ID of 5 to display a fifth image, the detection apparatus 300 may detect a portion of a difference image where the fifth image is displayed, as a layout of the display apparatus having an ID of 5. In the same manner, layouts of all of the display apparatuses 110 may be detected.

Also, since the IDs of the display apparatuses 110 are set based on a connection order, the detection apparatus 300 may check the connection relationship between the display apparatuses 110 in the difference image. For example, the detection apparatus 300 may check the connection relationship between the display apparatuses 110 by checking an image of each ID included in the difference image.

A detection apparatus according to the examples may detect a layout of a multi display apparatus based on an image of the multi display apparatus that is captured by an image capturing apparatus positioned inside or outside the multi display apparatus.

The detection apparatus according to the examples may capture images displayed by the display apparatuses and may detect a layout of the multi display apparatus based on a difference image between the captured images.

The detection apparatus according to the examples may detect a connection relationship between the display apparatuses by capturing images displayed by the display apparatuses connected in a daisy chain arrangement.

The device described herein may comprise a processor, a memory for storing program data and executing it, a permanent storage such as a disk drive, a communications port for handling communications with external devices, and user interface devices, including a touch panel, keys, buttons, etc. When software modules or algorithms are involved, these software modules may be stored as program instructions or computer readable codes executable on the processor on a computer-readable medium. Examples of the computer-readable recording medium include magnetic storage media (e.g., ROM, floppy disks, hard disks, etc.), and optical recording media (e.g., CD-ROMs, or DVDs). The computer-readable recording medium can also be distributed over network coupled computer systems so that the computer-readable code is stored and executed in a distributed fashion. This media can be read by the computer, stored in the memory, and executed by the processor.

The disclosure may be described in terms of functional block components and various processing steps. Such functional blocks may be realized by any number of hardware and/or software components configured to perform the specified functions.

For example, the disclosure may employ various integrated circuit (IC) components, e.g., memory elements, processing elements, logic elements, circuit elements, look-up tables, and the like, which may carry out a variety of functions under the control of one or more microprocessors or other control devices. Similarly, where the elements of the present disclosure are implemented using software programming or software elements, the present disclosure may be implemented with any programming or scripting language such as C, C++, Java, assembler language, or the like, with the various algorithms being implemented with any combination of data structures, objects, processes, routines or other programming elements. Functional aspects may be implemented in algorithms that are executed on one or more processors. Furthermore, the present disclosure could employ any number of conventional techniques for electronics configuration, signal processing and/or control, data processing and the like. The words “mechanism”, “element”, “means”, and “configuration” are used broadly and are not limited to mechanical or physical examples, but can include software routines in conjunction with processors, etc.

The particular implementations shown and described herein are illustrative examples of the disclosure and are not intended to otherwise limit the scope of the disclosure in any way. For the sake of brevity, conventional electronics, control systems, software development and other functional aspects of the systems may not be described in detail. Furthermore, the connecting lines, or connectors shown in the various figures presented are intended to represent example functional relationships and/or physical or logical couplings between the various elements. It should be noted that many alternative or additional functional relationships, physical connections or logical connections may be present in a practical device.

The use of the terms “a” and “an” and “the” and similar referents in the context of describing the disclosure (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Also, the steps of all methods described herein can be performed in any suitable order unless otherwise indicated herein or otherwise clearly contradicted by context. The disclosure is not limited to the described order of the steps. The use of any and all examples, or exemplary language (e.g., “such as”) provided herein, is intended merely to better illuminate the disclosure and does not pose a limitation on the scope of the disclosure unless otherwise claimed. Numerous modifications and adaptations will be readily apparent to one of ordinary skill in the art without departing from the spirit and scope of the disclosure.

What is claimed is:

1. A detection apparatus for detecting a layout of a multi display apparatus, the detection apparatus comprising:
a controller configured to control the multi display apparatus to display an image using a plurality of display apparatuses comprising the multi display apparatus, the controller further configured to control an image capturing capture an image of the multi display apparatus; and
an image analyzer configured to detect a layout of the multi display apparatus based on the image captured by the image capturing apparatus.

2. The detection apparatus of claim 1, wherein the controller is further configured to control the plurality of display apparatuses to sequentially display images and to control the image capturing apparatus to capture the image of the multi display apparatus whenever the plurality of display apparatuses sequentially display the images.

3. The detection apparatus of claim 2, wherein the image analyzer is further configured to detect a layout of the multi display apparatus based on a difference image representing a difference between a current image and a previous image which are captured by the image capturing apparatus.

4. The detection apparatus of claim 1, wherein the controller is further configured to control a display apparatus, selected from among the plurality of display apparatuses, to display the image and to control the image capturing apparatus to capture the image of the multi display apparatus when the selected display apparatus displays the image.

5. The detection apparatus of claim 4, wherein the image analyzer is further configured to detect the layout of the multi display apparatus based on a difference image representing a difference between a current image and an initial image which are captured by the image capturing apparatus.

6. The detection apparatus of claim 1, wherein the controller is further configured to control the plurality of display apparatuses to sequentially display images and to control the image capturing apparatus to capture the image of the multi display apparatus whenever the plurality of display apparatuses sequentially display the images, and
the image analyzer is further configured to detect whether the plurality of display apparatuses are arranged to overlap each other based on a polygon detected from a difference image representing a difference between a current image and a previous image which are captured by the image capturing apparatus.

7. The detection apparatus of claim 1, wherein the controller is further configured to check or set IDs of the plurality of display apparatuses, to control the plurality of display apparatuses to sequentially display images, and to control the image capturing apparatus to capture the image of the multi display apparatus whenever the plurality of display apparatuses sequentially display the images, and
the image analyzer is further configured to detect that the IDs of the plurality of display apparatuses include duplicate IDs when at least two rectangles are detected, the at least two rectangles being separated from a difference image representing a difference between a current image and a previous image which are output from the image capturing apparatus.

8. The detection apparatus of claim 1, wherein the controller is further configured to check or set IDs of the plurality of display apparatuses and to control the plurality of display apparatuses to simultaneously display different images, and
the image analyzer is further configured to detect layouts of the plurality of display apparatuses based on the image of the multi display apparatus that is captured by the image capturing apparatus, wherein the multi display apparatus is configured to display different images.

9. The detection apparatus of claim 1, wherein the controller is further configured to control the plurality of display apparatuses to simultaneously display images, and
the image analyzer is further configured to detect an entire layout of the plurality of display apparatuses based on the image of the multi display apparatus that is captured by the image capturing apparatus, wherein the image is captured while the plurality of display apparatuses included in the multi display apparatus are configured to simultaneously display the images.

10. The detection apparatus of claim 1, wherein the detection apparatus comprises the image capturing apparatus.

11. A detection apparatus for detecting a connection relationship of a multi display apparatus, the detection apparatus being configured to:
check or set IDs of display apparatuses connected according to a daisy chain method and control the display apparatuses to display images based on an order of the set IDs, and
detect the connection relationship of the multi display apparatus based on an image output from an image capturing apparatus configured to capture an image of the multi display apparatus which displays an image based on the order of the set IDs.

12. A method of detecting a layout of a multi display apparatus, comprising:
controlling the multi display apparatus to display an image;
controlling an image capturing apparatus to capture an image of the multi display apparatus; and
detecting the layout of the multi display apparatus based on the image captured by the image capturing apparatus.

13. The method of claim 12, wherein the multi display apparatus comprises a plurality of display apparatuses,
controlling the multi display apparatus comprises controlling the plurality of display apparatuses to sequentially display images, and
controlling the image capturing apparatus comprises controlling the image capturing apparatus to capture the image of the multi display apparatus whenever the plurality of display apparatuses sequentially display the images.

14. The method of claim 13, wherein detecting the layout comprises detecting the layout of the multi display apparatus based on a difference image representing a difference between a previous image and a current image which are captured by the image capturing apparatus.

15. The method of claim 12, wherein, controlling the multi display apparatus, includes controlling a display apparatus, selected from among the plurality of display apparatuses, to display an image, and
controlling the image capturing apparatus, includes controlling the image capturing apparatus to capture the image of the multi display apparatus when the selected display apparatus displays the image.

16. The method of claim 15, wherein detecting the layout comprises detecting the layout of the multi display apparatus based on a difference image representing a difference between an initial image and a current image which are output by the image capturing apparatus.

17. The method of claim 12, wherein, controlling the multi display apparatus, includes controlling the plurality of display apparatuses to sequentially display images,
controlling the image capturing apparatus, includes controlling the image capturing apparatus to capture the image of the multi display apparatus whenever the plurality of display apparatuses sequentially display the images, and
detecting the layout comprises detecting whether the plurality of display apparatuses are arranged by overlapping each other based on a polygon detected from a difference image representing a difference between a current image and a previous image which are output from the image capturing apparatus.

18. The method of claim 12, further comprising checking or setting IDs of the plurality of display apparatuses,
wherein, controlling the multi display apparatus, includes controlling the plurality of display apparatuses to sequentially display images,
controlling the image capturing apparatus, includes controlling the image capturing apparatus to capture the image of the multi display apparatus whenever the plurality of display apparatuses sequentially display the images, and
detecting the layout comprises detecting that the IDs of the plurality of display apparatuses include duplicate IDs when a rectangle is detected, the rectangle being separated from a difference image representing a difference between a current image and a previous image which are output from the image capturing apparatus.

19. The method of claim 12, further comprising checking or setting IDs of the plurality of display apparatuses,
wherein, controlling the multi display apparatus, includes controlling the plurality of display apparatuses to simultaneously display different images, and
detecting the layout, includes detecting layouts of the plurality of display apparatuses based on the image of the multi display apparatus that is captured by the image capturing apparatus.

20. The method of claim 12, wherein, controlling the multi display apparatus, includes controlling the plurality of display apparatuses to simultaneously display images, and
detecting the layout, includes detecting an entire layout of the plurality of display apparatuses based on the image of the multi display apparatus that is captured by the image capturing apparatus.
